(19) United States
(12) Patent Application Publication
(10) Pub. No.: US 2016/0170802 A1
(43) Pub. Date: Jun. 16, 2016

(54) OPTIMIZING SYSTEM PERFORMANCE

(71) Applicant: Bank of America Corporation, Charlotte, NC (US)

(72) Inventors: Durgadatta Belhekar, Mumbai (IN); Madhu Thatikonda, Hyderabad (IN); Yuvaraj Ramalingam, Hyderabad (IN); Daniel Widjanarko, San Francisco, CA (US); Katherine Rolfe, Saint Augustine, FL (US)

(21) Appl. No.: 14/567,708

(22) Filed: Dec. 11, 2014

(51) Int. Cl. G06F 9/50; G06F 11/34; G06F 11/30; G06F 9/54

(52) U.S. Cl. CPC G06F 9/5011; G06F 9/542; G06F 11/3495; G06F 11/302

(57) ABSTRACT

Embodiments of the invention are directed to systems, methods, and computer program products to optimize a performance of an application by monitoring and measuring health and usage of the application. In some embodiments, the system is configured to receive application statistics associated with an application, wherein the application statistics comprise at least one of a user capacity and a utilization capacity; monitor in real-time, the usage statistics associated with the application over a predetermined period of time; determine that the application is being over-utilized based on at least comparing the application statistics with the usage statics; and re-allocate at least one of a number of active users, a number of active reports, and a number of active documents based on at least determining that the application is being over-utilized.

### FIELD

In general, embodiments of the invention relate to the optimization of an application, in particular, embodiments of the invention relate to a comprehensive mechanism to monitor, measure, and optimize the usage of an application.

### BACKGROUND

Business Intelligence (BI) is a broad category of applications and technologies for gathering, storing, analyzing, and providing access to data to help enterprise users to make better business decisions. Both survival and growth for a large number of organizations across multiple businesses depends on the evolving and transformative nature of data and more importantly, the need to leverage the massive volume of data as an enterprise asset. Typically, BI systems are capable of handling large amounts of unstructured data to help identify, develop, and strategize new business opportunities. The primary goal of BI systems is to allow for the easy interpretation of these large volumes of data. It is imperative that these BI systems are continuously monitored to ensure that the involved technical systems and components are working as expected. Often, problems aren't detected until after a business user notices them: malfunctioning report, one or more reports providing conflicting results, failed process detection, or lack of disk space in the log drive.

There is a need for a comprehensive mechanism to monitor and measure the health and usage of a BI system.

### BRIEF SUMMARY

Embodiments of the present invention address the above needs and/or achieve other advantages by providing apparatuses (e.g., a system, computer program product, and/or other device) and methods for optimization of business intelligence system. The present invention is configured to present a comprehensive view of the health of a BI system from access usage to performance and optimize the implementation of BI systems in a business environment. A BI system generally hosts projects for multiple verticals/lines of business catering to thousands of business users and developers. Most businesses typically tend to be in a reactive mode when it comes to managing and balancing BI system metrics, whereby measuring these metrics tend to matter only when there is a performance deterioration risk, or a pending compliance failure. At that point, the metrics are identified to triage the failure, rather than compiling a set of performance indicators ahead of time. The present invention provides a solution to comprehensively monitor and measure the health and usage of a BI system by identifying and creating a set of metrics related to performance and exposure indicators.

In some embodiments, a system to optimize a performance of an application by monitoring and measuring health and usage of the application is presented. The system comprises: a computing platform including one or more computing processors, a memory in communication with the processor; a module stored in a memory, executable by a processor and configured to initiate a presentation of a first user interface to: receive application statistics associated with an application, wherein the application statistics comprise at least one of a user capacity and a utilization capacity, wherein the utilization capacity is based on at least a number of projects, a number of reports per project, and a number of attributes per report; determine usage statistics associated with the application, wherein the usage statistics are specific to a user type; monitor in real-time, the usage statistics associated with the application over a predetermined period of time, wherein the usage statistics comprise at least one of a number of active users, a number of active projects, a number of active reports, and a number of active documents; determine that the application is being over-utilized based on at least comparing the application statistics with the usage statics; and re-allocate at least one of a number of active users, a number of active reports, and a number of active documents based on at least determining that the application is being over-utilized.

In some embodiments, wherein the module is further configured to determine user profile statistics for a predetermined period of time, wherein the user profile statistics comprises a number of projects, a number of reports, and a number of documents associated with a user. In some embodiments, wherein the module is further configured to: determine one or more unused reports associated with a project subscribed by the user over a predetermined period of time; and determine that the one or more unused reports are a candidate to cancel the user's subscription.

In some embodiments, wherein the module is further configured to: determine one or more unused attributes associated with a report subscribed by the user over a predetermined period of time; and determine that the one or more unused attributes are a candidate to cancel the user's subscription.

In some embodiments, wherein the module is further configured to determining a latest user access date when the user has accessed the application to execute a report, a frequency of user access, and a current status of the user; and determining whether the user access to the application is to be revoked based on at least the latest user access date, the frequency of user access, and the current status of the user.

In some embodiments, wherein the module is further configured to verify one or more authentication credentials associated with each user type to enable access to the application, wherein the user type used by said at least one processor to determine usage statistics comprises at least one of an application developer, an administrator, a business user, and a business executive.

In some embodiments, wherein the module is further configured to: determine a top report associated with a project based on at least a number of times a user has executed the report using the application and a frequency of execution of the top report using the application; determine that an average amount of time associated with the execution of the top report by the user is greater than a predetermined threshold time, thereby causing an application laggard, wherein the top report is executed after an authorization of user access to the application; execute the top report prior to the authorized user access based on the frequency of execution of the top report; and transmit the executed top report to the user, thereby enabling the user to access the executed top report without the need for the user to access the application to execute the top report.

In some embodiments, a method to optimize a performance of an application by monitoring and measuring health and usage of the application is presented. The method comprises: receiving, using a computing device processor, application statistics associated with an application, wherein the application statistics comprise at least one of a user capacity and a utilization capacity, wherein the utilization capacity is based on at least a number of projects, a number of reports per project, and a number of attributes per report; determining, using a computing device processor, usage statistics associated with the application, wherein the usage statistics are specific to a user type; monitoring, using a computing device processor, in real-time, the usage statistics associated with the application over a predetermined period of time, wherein the usage statistics comprise at least one of a number of active users, a number of active projects, a number of active reports, and a number of active documents; determining, using a computing device processor, that the application is being over-utilized based on at least comparing the application statistics with the usage statics; and re-allocating, using a computing device processor, at least one of a number of active users, a number of active reports, and a number of active documents based on at least determining that the application is being over-utilized.

In some embodiments, a computer program product to optimize a performance of an application by monitoring and measuring health and usage of the application is presented. The computer program product comprises a non-transitory computer-readable medium comprising code causing a first apparatus to: receive application statistics associated with an application, wherein the application statistics comprise at least one of a user capacity and a utilization capacity, wherein the utilization capacity is based on at least a number of projects, a number of reports per project, and a number of attributes per report; determine usage statistics associated with the application, wherein the usage statistics are specific to a user type; monitor in real-time, the usage statistics associated with the application over a predetermined period of time, wherein the usage statistics comprise at least one of a number of active users, a number of active projects, a number of active reports, and a number of active documents; determine that the application is being over-utilized based on at least comparing the application statistics with the usage statics; and re-allocate at least one of a number of active users, a number of active reports, and a number of active documents based on at least determining that the application is being over-utilized.

### BRIEF DESCRIPTION OF THE DRAWINGS

Having thus described embodiments of the invention in general terms, reference will be made to the accompanying drawings, where:

FIG. 1 presents a high level process flow to optimize a performance of an application by monitoring and measuring health and usage of the application according to one aspect of the present invention.

FIG. 2 presents a high level process flow to determine a top report and execute the top report without the need for a user to access the application according to one aspect of the present invention.

FIG. 3 presents a system environment to optimize a performance of an application according to one aspect of the present invention.

FIG. 4 illustrates an exemplary user interface to monitor usage statistics and utilization statistics associated with the application environment according to one aspect of the present invention.

FIG. 5 illustrates a user interface to monitor usage statistics and utilization statistics associated with a particular project according to one aspect of the present invention.

FIG. 6 illustrates a user interface to monitor top reports according to one aspect of the present invention.

FIG. 7 illustrates a user interface for attributes and report statistics according to one aspect of the present invention.

### DETAILED DESCRIPTION OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Business Intelligence (BI) is a set of techniques and tools for the transformation of raw data into meaningful and useful information for business analysis purposes. BI systems are generally capable of handling large amounts of unstructured data to help identify, develop, and otherwise create new strategic business opportunities. BI systems can be mission-critical and integral to a business' operations, occasional to meet a special requirement, enterprise-wide or local to one division, centrally initiated or driven by user demand. On a tactical level, BI systems may provide some basis for decision making within marketing, sales, finance, capital management, or the like. The systems allow for optimizing future actions and for modifying organizational, financial, or technological aspects of company performance appropriately to help businesses realize their strategic objectives more effectively.

In the current competitive business environment, managers, developers, and business executives alike require real-time visibility into the status of their business processes. However, in the current business approach, there is a gap between monitoring the health of the business intelligence system and action. Traditional BI systems are reactive when dealing with system laggards. In this regard, measuring BI system metrics tend to be an afterthought, and tend to only come into play when there is a performance deterioration risk, or a pending compliance failure.

The present invention overcomes these challenges by identifying and creating a set of metrics, related to performance and health, at an appropriate juncture that will enable application managers to be proactive in managing their environment and addressing impending failures before they occur. Furthermore, the present invention has the functional benefit of being integrated into the genesis of any application in the business environment, consisting of a set of steps that can be standardized and replicated. As each application in the business environment caters to the needs to a specific user type, the present invention is configured to receive user inputs associated with each application to identify key performance indicators specific to the application and the user type to determine optimized functioning.

As used herein, an “application” may be a software application capable of converting, validating, sorting, summarizing, aggregating, and analyzing large volumes of data. Data can be related to all facets of the business, such as customer transactions, customer demographics, company financial information, manufacturing processes, inventory management, industry trends, supplier transactions, and competitor profiles. Data is typically collected from internal sources, such as transaction systems, manufacturing processes, customer records, as well as external sources such as consultant and industry studies, the printed media, and the Internet. In some embodiments, the application may be a business intelligence application capable of combining operational data with analytical tools to present complex and competitive information to planners and decision makers. In some embodiments, an application may be specific to a particular user type. In this regard, for an integrated solution, the application may require both application-specific coding and user-specific coding for acquiring the data and transforming data into an adequate representation. The system described herein may be seamlessly integrated with the business intelligence application in a business environment to manage or otherwise control the development.

As used herein, an “active user” may be any user currently logged into the application, or currently executing a report, or a combination of both. In one aspect, a user who is not logged into the application currently may still be considered an active user, if that user had previously logged into the application during a predetermined period of time during which the application usage statistics are monitored. As used herein, an “active project” may be any project processed by a user during a predetermined period of time during which the application usage statistics are monitored. As used herein, an “active report” may be any report executed by a user during a predetermined period of time during which the application usage statistics are monitored. As used herein, an “active document” may be any document generated by the user during a predetermined period of time during which the application usage statistics are monitored.

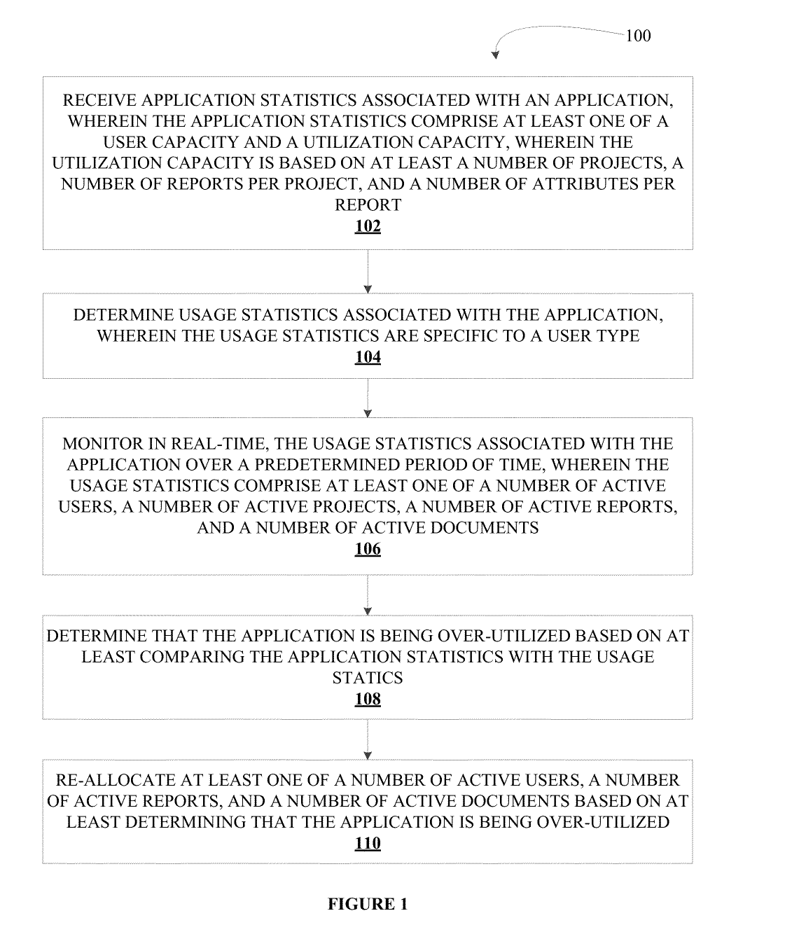

FIG. 1 illustrates a high level process flow 100 to optimize a performance of an application by monitoring and measuring health and usage of the application. As shown in block 102, the process flow comprises receiving application statistics associated with an application, wherein the application statistics comprise at least one of a user capacity and a utilization capacity, wherein the utilization capacity is based on at least a number of projects, a number of reports per project, and a number of attributes per report. Typically, application statistics are used to estimate the computer resources required to meet an application's service level objectives over time. In this regard, the application capacity may include a user capacity and a utilization capacity to allow the optimal amount of workload through the system to meet specific objectives. There are a number of ways to analyze user capacity. In one aspect, the user capacity may be a raw total number of users that have access to the application. Many of them may be occasional and sporadic users signing on infrequently. In another aspect, a user capacity may be a number of users that log on to the application concurrently. This value gives an indication of how many users may be executing queries in the same time frame. In some embodiments, while there may be a significant number of users logged onto the system, the number of users executing queries concurrently may be a small number. In another embodiment, a user capacity may include a number of users that execute queries concurrently in the application. In this regard, the number of users that execute queries concurrently in the application directly impacts data accessibility and the workload capacity.

An important aspect relating to the number of users is that most business intelligence systems are often accessed by a number of business units or departments within the business environment. In this regard, the number of users may be categorized into one or more user types. In one aspect, the user type may include administrators who monitor the application as a whole. In another aspect, the user type may include business users who identify popular reports and dashboards, monitor user usage, and identify laggards in the system. Typically, laggards in the system may be caused by factors including, but not restricted to, a sluggish client, a slow server, diminutive databases, outstanding requests, slow network services, or the like. In yet another aspect, the user type may include a developer/architect of the application capable of identifying one or more unused objects/attributes in the application to optimize performance of the application. In yet another embodiment, the user type may include business executives who identify return on investment (ROI) on each project executed by the application. In yet another embodiment, the user type may include a single person of contact (SPOC) from one or more business groups involved in user administration. In this regard, each user type may be associated with a specific set of key performance indicators (KPIs) and/or service level agreements (SLAs) associated with each application. In some embodiments, the user capacity of the application may be based on a user type. In this regard, the system may be configured to determine a utilization capacity for the application based on each user type.

In some embodiments, the utilization capacity may include a workload capacity. In this regard, the utilization capacity may be based on a number of users, an amount of data, a size and complexity of a workload, or the like. Each report may include one or more attributes/objects that populate the report and enable the user to comprehend and analyze the data. For example, an attribute/object in a report may be a line graph representing a dataset over a period of time. In another example, an attribute/object in a report may be a graphical indicator representing compliance to a specific set of rules. In one aspect, each attribute/object may be associated with one or more service level agreements (SLAs) specific to one or more user types. In one aspect, each report may include one or more documents capable of being generated to summarize the result-set based on execution of one or more queries.

The process flow then determines usage statistics associated with the application, wherein the usage statistics are specific to a user type as shown in block 104. In some embodiments, each user type requires a specific set of key performance indicators to be monitored. For example, an administrator may require usage statistics associated with the entire application, i.e., total number of projects executed, a total number of active users across every active project executed by the application, a total number of reports generated across every active project executed by the application, or the like. In another example, a business user may require usage statistics that identifies popular reports/dashboards, monitor the number of users, and identify laggards in the system. In yet another example, a developer/architect may require usage statistics associated with attributes in an application that have been used, or have remained unused for a predetermined period of time. In yet another example, business executives may require usage statistics associated with identifying return on investment (ROI) on the project currently being associated with the application. In yet another example, primary contacts or specific point of contact (SPOC) for each business group may be interested in usage statistics associated with managing user access and monitor authorization.

In some embodiments, each user may be required one or more authentication credentials specific to a user type. In one aspect, the authentication credentials may include one or more authentication types such as a username, a password, a PIN, a keyfob, a challenge-response test, hardware token, software token, a biometric authentication, or the like. In another aspect, the authentication credentials may include a combination of one or more authentication types to gain authorized access to an application. In one aspect, the authentication type requirement may be characterized into a low authentication profile, a medium authentication profile, or a high authentication profile. In this regard, the authentication profile may be specific to each user type and a level of access associated with the application. For example, a system may require low authentication profile for business users, a medium authentication profile for a developer/architect to access the source code associated with a specific project, and a high authentication profile for an administrator to access the entire application environment.

In response, the process flow then monitors in real-time, the usage statistics associated with the application over a predetermined period of time, wherein the usage statistics comprise at least one of a number of active users, a number of active projects, a number of active reports, and a number of active documents, as shown in block 106. In this regard, monitoring may be based on an application environment level, a project level within the application environment, a report level within a project, or a document level within a report. As such, the system may be configured to estimate the computer resources required to meet an application's service-level objectives over time. In one aspect, the system may be configured to estimate an amount of computing resources required to support future processing needs of an existing workload. In this regard, the system may be configured to monitor in real-time, resource usage of a current workload, together with user feedback to understand future requirement (e.g., performance requirements, data requirements, and growth in the number of users).

Accordingly, the process flow determines that that the application is being over-utilized based on at least comparing the application statistics with the usage statics, as shown in block 108. For example, an application may initially be configured to handle a maximum of 100 concurrent users. If the number of concurrent users exceeds the maximum, the application is considered to be overworked or over-utilized. On the other hand, if the number of concurrent users is below 50, then the application is said to be under-utilized. Typically, the size of the workload may be based on at least a number of reports, a number of attributes associated with each of the reports, and/or a number of documents associated with each of the reports. Authorized users may present one or more queries to generate a report, in order to collect and present data so that it can be analyzed and presented to the users to be understood and manipulated. In some embodiment, the workload capacity may vary based on the nature of the query. In this regard, the application may be configured to handle 100 concurrent users, with each user executing one or more queries comprising a predetermined workload. In this case, even if the application is handling 90 users, but each user is executing a query comprising a workload greater than the predetermined workload, then the application is considered to be over-utilized. On the other hand, if the application is handling 150 concurrent users, each user executing queries comprising a workload considerably lower than a predetermined workload, then the application is considered to be under-utilized. In some embodiments, application utilization may be defined as a gradient with one or more capacity levels ranging from under-utilized, optimum, to over-utilized. In response, the process flow includes re-allocating at least one of a number of active users, a number of active reports, and a number of active documents based on at least determining that the application is being over-utilized, as shown in block 110. In this way, one or more application statistics, alone or in combination with each other, may be used to determine whether the application is being under-utilized or over-utilized for adequate re-allocation of resources.

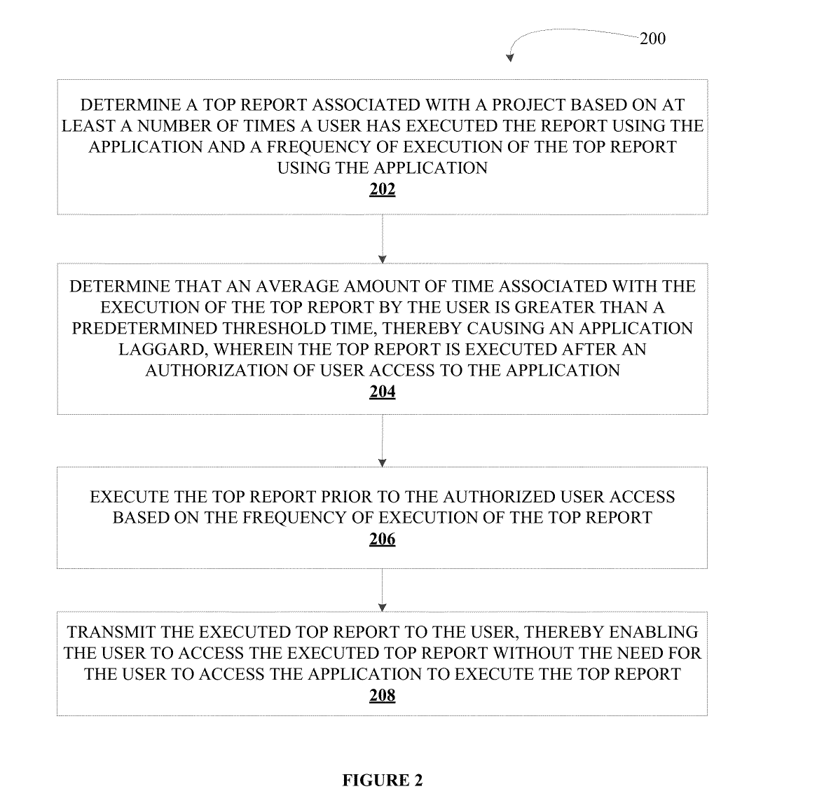

FIG. 2 presents a high level process flow to determine a top report and execute the top report without the need for a user to access the application 200. As shown in block 202, the process flow includes determining a top report associated with a project based on at least a number of times a user has executed the report using the application and a frequency of execution of the top report using the application. In response, the process flow includes determining that an average amount of time associated with the execution of the top report by the user is greater than a predetermined threshold time, thereby causing an application laggard, wherein the top report is executed after an authorization of user access to the application, as shown in block 204. In this regard, the user is required to initially gain access to the application prior to being able to execute the top report. Typically, one or more users may access an application to execute one or more reports during normal business hours. In such cases, if the top report is accessed by plurality users at the same time, the utilization/workload capacity of the application may be greatly affected. In this regard, the process may then execute the top report prior to the authorized user access based on the frequency of execution of the top report, as shown in block 206. In one aspect, executing the top report prior to the authorized user access may include executing the top report during hours when the application is minimally used. This may be determined based on an analysis of the application utilization over a predetermined period of time in the past. In some embodiments, the hours when the application is minimally used may be during non-business hours. In other embodiments, the hours when the application is minimally used may be during specific time slots during business hours. In response to executing the report prior to the authorized user access, the process flow includes transmitting the executed top report to the user, thereby enabling the user to access the executed top report without the need for the user to access the application to execute the top report, as shown in block 208.

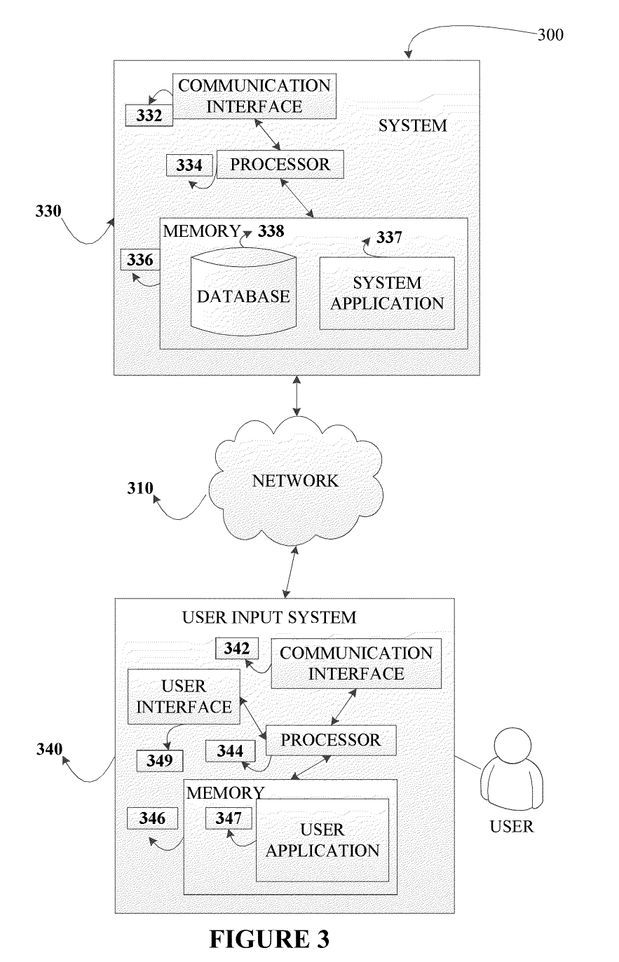

FIG. 3 presents an exemplary block diagram of the system environment 300 for implementing the process flows described herein in accordance with embodiments of the present invention. As illustrated, the system environment 300 includes a network 310, a system 330, and a user input system 340. Also shown in FIG. 3 is a user of the user input system 340. The user input system 340 may be a mobile device or other non-mobile computing device. The user may be a person who uses the user input system 340 to execute a user application 347. The user application 347 may be an application to communicate with the system 330, perform a transaction, input information onto a user interface presented on the user input system 340, or the like. The user application 347 and/or the system application 337 may incorporate one or more parts of any process flow described herein.

As shown in FIG. 3, the system 330, and the user input system 340 are each operatively and selectively connected to the network 310, which may include one or more separate networks. In addition, the network 310 may include a telecommunication network, local area network (LAN), a wide area network (WAN), and/or a global area network (GAN), such as the Internet. It will also be understood that the network 310 may be secure and/or unsecure and may also include wireless and/or wired and/or optical interconnection technology.

The user input system 340 may include any computerized apparatus that can be configured to perform any one or more of the functions of the user input system 340 described and/or contemplated herein. For example, the user may use the user input system 340 to transmit and/or receive information or commands to and from the system 330. In some embodiments, for example, the user input system 340 may include a personal computer system (e.g. a non-mobile or non-portable computing system, or the like), a mobile computing device, a personal digital assistant, a mobile phone, a tablet computing device, a network device, and/or the like. As illustrated in FIG. 3, in accordance with some embodiments of the present invention, the user input system 340 includes a communication interface 342, a processor 344, a memory 346 having an user application 347 stored therein, and a user interface 349. In such embodiments, the communication interface 342 is operatively and selectively connected to the processor 344, which is operatively and selectively connected to the user interface 349 and the memory 346. In some embodiments, the user may use the user application 347 to execute processes described with respect to the process flows described herein. Specifically, the user application 347 executes the process flows described herein.

Each communication interface described herein, including the communication interface 342, generally includes hardware, and, in some instances, software, that enables the user input system 340, to transport, send, receive, and/or otherwise communicate information to and/or from the communication interface of one or more other systems on the network 310. For example, the communication interface 342 of the user input system 340 may include a wireless transceiver, modem, server, electrical connection, and/or other electronic device that operatively connects the user input system 340 to another system such as the system 330. The wireless transceiver may include a radio circuit to enable wireless transmission and reception of information. Additionally, the user input system 340 may include a positioning system. The positioning system (e.g. a global positioning system (GPS), a network address (IP address) positioning system, a positioning system based on the nearest cell tower location, or the like) may enable at least the user input system 340 or an external server or computing device in communication with the user input system 340 to determine the location (e.g. location coordinates) of the user input system 340.

Each processor described herein, including the processor 344, generally includes circuitry for implementing the audio, visual, and/or logic functions of the user input system 340. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the user application 347 of the memory 346 of the user input system 340.

Each memory device described herein, including the memory 346 for storing the user application 347 and other information, may include any computer-readable medium. For example, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 346 includes the user application 347. In some embodiments, the user application 347 includes an interface for communicating with, navigating, controlling, configuring, and/or using the user input system 340. In some embodiments, the user application 347 includes computer-executable program code portions for instructing the processor 344 to perform one or more of the functions of the user application 347 described and/or contemplated herein. In some embodiments, the user application 347 may include and/or use one or more network and/or system communication protocols.

Also shown in FIG. 3 is the user interface 349. In some embodiments, the user interface 349 includes one or more output devices, such as a display and/or speaker, for presenting information to the user. In some embodiments, the user interface 349 includes one or more input devices, such as one or more buttons, keys, dials, levers, directional pads, joysticks, accelerometers, controllers, microphones, touchpads, touchscreens, haptic interfaces, microphones, scanners, motion detectors, cameras, and/or the like for receiving information from the user. In some embodiments, the user interface 349 includes the input and display devices of a mobile device, which are operable to receive and display information.

FIG. 3 also illustrates a system 330, in accordance with an embodiment of the present invention. The system 330 may refer to the “apparatus” described herein. The system 330 may include any computerized apparatus that can be configured to perform any one or more of the functions of the system 330 described and/or contemplated herein. In accordance with some embodiments, for example, the system 330 may include a computer network, an engine, a platform, a server, a database system, a front end system, a back end system, a personal computer system, and/or the like. Therefore, the system 330 may be a server managed by the business. The system 330 may be located at the facility associated with the business or remotely from the facility associated with the business. In some embodiments, such as the one illustrated in FIG. 3, the system 330 includes a communication interface 332, a processor 334, and a memory 336, which includes a system application 337 and a structured database 338 stored therein. As shown, the communication interface 332 is operatively and selectively connected to the processor 334, which is operatively and selectively connected to the memory 336.

It will be understood that the system application 337 may be configured to implement any one or more portions of the various user interfaces and/or process flow described herein. The system application 337 may interact with the user application 347. It will also be understood that, in some embodiments, the memory includes other applications. It will also be understood that, in some embodiments, the system application 337 is configured to communicate with the structured database 338, the user input system 340, or the like.

It will be further understood that, in some embodiments, the system application 337 includes computer-executable program code portions for instructing the processor 334 to perform any one or more of the functions of the system application 337 described and/or contemplated herein. In some embodiments, the system application 337 may include and/or use one or more network and/or system communication protocols.

In addition to the system application 337, the memory 336 also includes the structured database 338. As used herein, the structured database 338 may be one or more distinct and/or remote databases. In some embodiments, the structured database 338 is not located within the system and is instead located remotely from the system. In some embodiments, the structured database 338 stores information or data described herein.

It will be understood that the structured database 338 may include any one or more storage devices, including, but not limited to, datastores, databases, and/or any of the other storage devices typically associated with a computer system. It will also be understood that the structured database 338 may store information in any known way, such as, for example, by using one or more computer codes and/or languages, alphanumeric character strings, data sets, figures, tables, charts, links, documents, and/or the like. Further, in some embodiments, the structured database 338 may include information associated with one or more applications, such as, for example, the system application 337. It will also be understood that, in some embodiments, the structured database 338 provides a substantially real-time representation of the information stored therein, so that, for example, when the processor 334 accesses the structured database 338, the information stored therein is current or substantially current.

It will be understood that the embodiment of the system environment illustrated in FIG. 3 is exemplary and that other embodiments may vary. As another example, in some embodiments, the system 330 includes more, less, or different components. As another example, in some embodiments, some or all of the portions of the system environment 300 may be combined into a single portion. Likewise, in some embodiments, some or all of the portions of the system 330 may be separated into two or more distinct portions.

In addition, the various portions of the system environment 300 may be maintained for and/or by the same or separate parties. It will also be understood that the system 330 may include and/or implement any embodiment of the present invention described and/or contemplated herein. For example, in some embodiments, the system 330 is configured to implement any one or more of the embodiments of the process flows described and/or contemplated herein in connection any process flow described herein. Additionally, the system 330 or the user input system 340 is configured to initiate presentation of any of the user interfaces described herein.

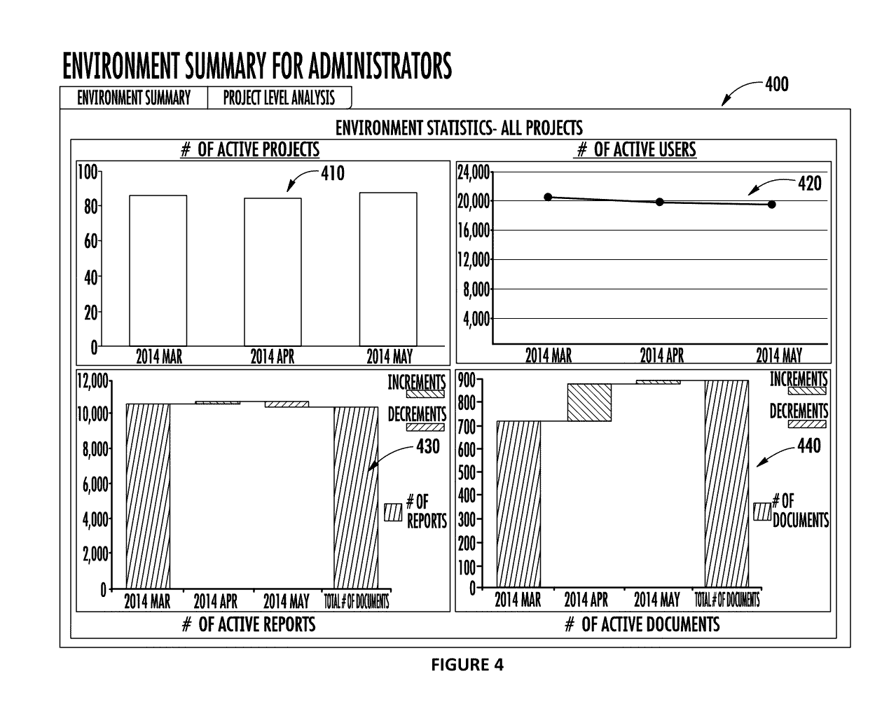

FIG. 4 illustrates an exemplary user interface to monitor usage statistics and utilization statistics associated with the application environment 400. As shown, the user interface 400 comprises a number of active projects 410, a number of active users 420, a number of active reports 430, and a number of active documents 440. In some embodiments, the system may be configured to determine an increase or decrease in the usage statistics during a predetermined period of time. In one aspect, the system may be configured to provide project level details associated with the number of active projects 410 monitored during the predetermined period of time. In another aspect, the system may be configured to provide information associated with each of the plurality of active users in the application environment monitored during the predetermined period of time 420. In yet another aspect, the system may be configured to provide report level details associated with the number of active reports 430 in the application environment monitored during the predetermined period of time. In yet another aspect, the system may be configured to provide document level details associated with the number of active documents 440 in the application environment monitored during the predetermined period of time.

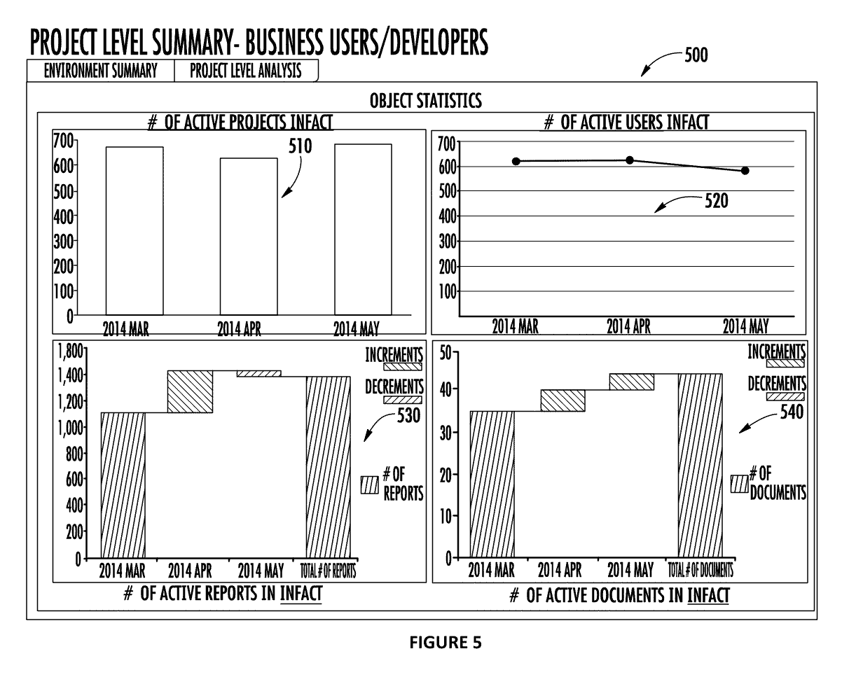

FIG. 5 illustrates a user interface to monitor usage statistics and utilization statistics associated with a particular project 500. As shown, the user interface 500 includes a number of active attributes 510, a number of active users 520, a number of active reports 530, and a number of active documents 540. In one aspect, the system may be configured to provide attribute level details associated with the number of active attributes 510 in the project monitored during the predetermined period of time. In another aspect, the system may be configured to provide information associated with each of the plurality of active users associated with the project monitored during the predetermined period of time. In yet another aspect, the system may be configured to provide report level details associated with the number of active reports 530 in the project monitored during the predetermined period of time. In yet another aspect, the system may be configured to provide document level details associated with the number of active documents 540 in the project monitored during the predetermined period of time.

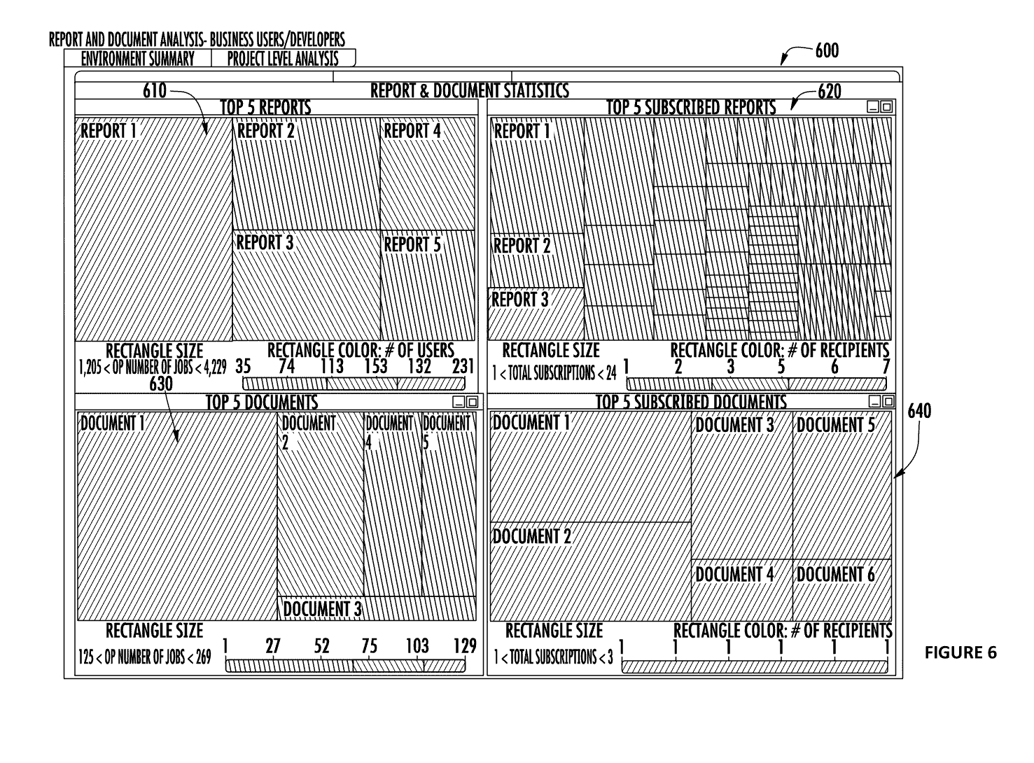

FIG. 6 illustrates a user interface to monitor top reports 600. As shown in the user interface 600, the user interface 600 includes top 5 reports executed by one or more users with authorized access to the application 610. In some embodiments, the top 5 reports are determined based on at least a number of times a report has been executed, an amount of data, a report complexity, and a query workload. In other words, the top 5 reports are selected based on the amount of resources required to execute each report. In one aspect, the top 5 reports are chosen based on the number of times the report has been executed during a predetermined period of time. In one aspect, the report complexity is based on at least a number of attributes associated with the report and workload complexity associated with each attribute. In some embodiments, the user interface 600 comprises top 5 reports subscribed to by the plurality of users 620. Typically, subscription based reporting is a configuration that delivers a report to a user at a specific time or in response to a specific event, in a specific format. Subscriptions can be used to schedule and automate the delivery of a report with a specific set of report parameter values specified by a user. As shown in the user interface 600, the user interface 600 includes top 5 documents executed by one or more users with authorized access to the application 630. In some embodiments, the user interface 600 comprises top 5 documents subscribed to by the plurality of users 640.

In some embodiments, the system may be configured to determine that at least one of the top 5 reports generated over a predetermined period of time is not part of the top 5 reports subscribed to by the plurality of users. In response, the system may be configured to select the at least one of the top 5 reports as a candidate for re-allocation. In this regard, the system may be configured to execute at least one of the top 5 reports prior to the authorized user access and transmit at least one of the top 5 executed reports to the user. In this way, the user may not be required to access the application and initiate the execution of the report, thereby decreasing the amount of workload on the application. In some other embodiments, the system may be configured to determine a total number of report subscriptions associated with a particular user. In response, reevaluate the number of report subscriptions to re-allocate resources to optimize the performance of the application. Similarly, the system may be configured to optimize the performance of the application based on the top 5 documents subscribed to by the plurality of users.

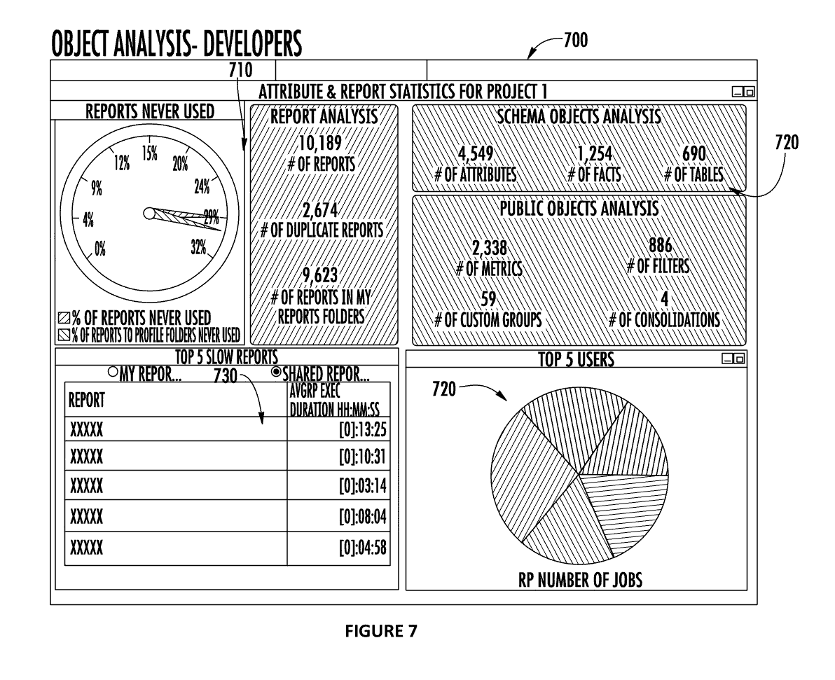

FIG. 7 illustrates a user interface for attributes and report statistics 700 to provide an object-level analysis for a developer/architect associated with the report. In some embodiments, the user interface 700 includes a statistical analysis of one or more attributes and reports executed by the application for a specific project 710. In one aspect, the user interface comprises a graphical representation of a number of reports that have never been used 702. In some embodiments, the user interface 700 includes a percentage of reports that have been developed by an architect/developer but have not been used for a predetermined period of time (e.g., for the past week, past month, or the like). In other embodiments, the user interface 700 includes a percentage of reports that have been subscribed to by a user but have not been used by the user for a predetermined period of time. In one aspect, the user interface 700 includes a number of reports associated with an application, a number of duplicate reports, and a number of reports subscribed to by a user associated with the application. In some embodiments, a number of duplicate reports may be based on two or more redundant reports stored under the same name in the database. The system may then be configured to select these redundant reports as a candidate for optimization by removing duplicates. In some embodiments, the percentage of reports that have been subscribed to by a user but have not been used by the user for a predetermined period of time may be based on the number of reports subscribed to by the user associated with the application.

In one aspect, the user interface 700 includes information associated with one or more objects in the report 720. In one aspect, the one or more objects include schema objects and public objects. Typically, schema objects and public objects are used to add different types of reporting flexibility and functionality to a business intelligence application. In one aspect, schema objects include statistical data comprising a number of attributes, a number of facts, and a number of tables associated with the report. In another aspect, public objects including statistical data comprising a number of metrics, filters, custom groups, and consolidations. The system may be configured to select one or more objects such as attributes, facts, tables, metrics, filters, custom groups, or consolidations as a candidate for optimization by determining whether the number of attributes, facts, tables, metrics, filters, custom groups, or consolidations is greater than a predetermined threshold. In one aspect, optimization may include deleting one or more unused or underutilized objects. In another aspect, optimization may include determining whether the project can be split into two or more sub-projects, thereby re-allocating resources.

In another aspect, the user interface 700 includes the top 5 slow reports 730 across the application environment. In some embodiments, the top 5 slow reports may be determined based on an amount of execution time required to successfully generate the report. In this regard, the system may be configured to determine the cause of the laggard. In one aspect, the laggard associated with the execution of the report may be due to at least one of an amount of data associated with the query, a number of objects associated with the report, a number of users executing the report concurrently, or the like. In response to determining the cause, the system may be configured to decrease the execution time associated with the report. In this regard, the system may be configured to at least split the report into two or more entities, restrict the number of users concurrently executing the report, remove one or more unused/underutilized objects in the report, or the like. In one aspect, the system may divide the amount of data into two or more batches to decrease execution time. In some embodiments, the user interface 700 may be configured to determine the top 5 slow reports associated with a user profile. In this regard, the system may be configured to determine the cause of the laggard and similarly initiate one or more actions to remedy the cause of the laggard by at least splitting the report into two or more entities, restricting the number of users concurrently executing the report, removing one or more unused/underutilized objects in the report, or the like.

In yet another aspect, the user interface 700 includes the top 5 users associated with the report 740. In this regard, the system may be configured to determine the top 5 users based on at least the number of times each user has executed a report. In one aspect, the system may be configured to receive one or more inputs from the top 5 users to initiate one or more actions to improve user performance. For example, the system may determine whether at least one of the top 5 users may require one or more reports executed prior to an authorized user access and be transmitted to the user.

In some embodiments, the system may be configured to manage user access to the application. In this regard, the system may be configured to determine a comprehensive list of users that have accessed the application to execute one or more reports associated with a project over a predetermined period of time and a list of users associated with the project, but have not accessed the application to execute one or more reports associated with the project over a predetermined period of time. In some other embodiments, the system may be configured to determine a list of reports associated with a project that have not been executed over a predetermined period of time and select the list of reports as candidates for deletion.

In some embodiments, the system may be configured to manage user access by determining a user profile analysis. In this regard, the system may be configured to compare user profile activity in the application environment with the user activity associated with the generation of one or more reports associated with a project. For example, the system may determine one or more users active within the last 150 days with no profile activity in 18 months. In another example, the system may determine one or more users with no activity in the last 150 days that have profile reports. In yet another example, the system may determine one or more terminated users with profile reports.

In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system to optimize a performance of an application by monitoring and measuring health and usage of the application, the system comprising:
at least non-transitory storage device;
at least one processor; and
at least one module stored in said storage device and comprising instruction code that is executable by the at least one processor and configured to cause said at least one processor to:
receive application statistics associated with an application, wherein the application statistics comprise at least one of a user capacity and a utilization capacity, wherein the utilization capacity is based on at least a number of projects, a number of reports per project, and a number of attributes per report;
determine usage statistics associated with the application, wherein the usage statistics are specific to a user type;
monitor in real-time, the usage statistics associated with the application over a predetermined period of time, wherein the usage statistics comprise at least one of a number of active users, a number of active projects, a number of active reports, and a number of active documents;
determine that the application is being over-utilized based on at least comparing the application statistics with the usage statics; and
re-allocate at least one of a number of active users, a number of active reports, and a number of active documents based on at least determining that the application is being over-utilized.

2. The system of claim 1, wherein the instruction code of said module for causing the at least one processor to determine that the application is being over-utilized further comprises instruction code to cause the at least one processor to:
determine that the number of active users is greater than the user capacity of the application; or
determine that the number of active projects being executed by the application is greater than the utilization capacity of the application.

3. The system of claim 1, wherein said module further comprises instruction code for causing said at least one processor to determine user profile statistics for a predetermined period of time, wherein the user profile statistics comprises a number of projects, a number of reports, and a number of documents associated with a user.

4. The system of claim 1, wherein said module further comprises instruction code for causing said at least one processor to:
determine one or more unused reports associated with a project subscribed by the user over a predetermined period of time; and
determine that the one or more unused reports are a candidate to cancel the user's subscription.

5. The system of claim 1, wherein said module further comprises instruction code for causing said at least one processor to:
determine one or more unused attributes associated with a report subscribed by the user over a predetermined period of time; and
determine that the one or more unused attributes are a candidate to cancel the user's subscription.

6. The system of claim 1, wherein said module further comprises instruction code for causing said at least one processor to:
determine a latest user access date when the user has accessed the application to execute a report, a frequency of user access, and a current status of the user; and
determine whether the user access to the application is to be revoked based on at least the latest user access date, the frequency of user access, and the current status of the user.

7. The system of claim 1, wherein the module further comprises instruction code to verify one or more authentication credentials associated with each user type to enable access to the application, wherein the user type used by said at least one processor to determine usage statistics comprises at least one of an application developer, an administrator, a business user, and a business executive.

8. The system of claim 1, wherein said module further comprises instruction code for causing said at least one processor to:
determine a top report associated with a project based on at least a number of times a user has executed the report using the application and a frequency of execution of the top report using the application;
determine that an average amount of time associated with the execution of the top report by the user is greater than a predetermined threshold time, thereby causing an application laggard, wherein the top report is executed after an authorization of user access to the application;
execute the top report prior to the authorized user access based on the frequency of execution of the top report; and
transmit the executed top report to the user, thereby enabling the user to access the executed top report without the need for the user to access the application to execute the top report.

9. A computer implemented method to optimize a performance of an application by monitoring and measuring health and usage of the application, the method comprising:
receiving, using a computing device processor, application statistics associated with an application, wherein the application statistics comprise at least one of a user capacity and a utilization capacity, wherein the utilization capacity is based on at least a number of projects, a number of reports per project, and a number of attributes per report;
determining, using a computing device processor, usage statistics associated with the application, wherein the usage statistics are specific to a user type;
monitoring, using a computing device processor, in real-time, the usage statistics associated with the application over a predetermined period of time, wherein the usage statistics comprise at least one of a number of active users, a number of active projects, a number of active reports, and a number of active documents;
determining, using a computing device processor, that the application is being over-utilized based on at least comparing the application statistics with the usage statics; and
re-allocating, using a computing device processor, at least one of a number of active users, a number of active reports, and a number of active documents based on at least determining that the application is being over-utilized.

10. The method of claim 9, wherein determining that the application is being over-utilized further comprises:
determining that the number of active users is greater than the user capacity of the application; or
determining that the number of active projects being executed by the application is greater than the utilization capacity of the application.

11. The method of claim 9 further comprises:
determining one or more unused reports associated with a project subscribed by the user over a predetermined period of time; and
determining that the one or more unused reports are a candidate to cancel the user's subscription.

12. The method of claim 9 further comprises:
determining one or more unused attributes associated with a report subscribed by the user over a predetermined period of time; and
determining that the one or more unused attributes are a candidate to cancel the user's subscription.

13. The method of claim 9 further comprises:
determining a latest user access date when the user has accessed the application to execute a report, a frequency of user access, and a current status of the user; and
determining whether the user access to the application is to be revoked based on at least the latest user access date, the frequency of user access, and the current status of the user.

14. The method of claim 9 further comprises:
determining a top report associated with a project based on at least a number of times a user has executed the report using the application and a frequency of execution of the top report using the application;
determining that an average amount of time associated with the execution of the top report by the user is greater than a predetermined threshold time, thereby causing an application laggard, wherein the top report is executed after an authorization of user access to the application;
executing the top report prior to the authorized user access based on the frequency of execution of the top report; and
transmitting the executed top report to the user, thereby enabling the user to access the executed top report without the need for the user to access the application to execute the top report.

15. The method of claim 9, wherein the method further comprises determining user profile statistics for a predetermined period of time, wherein the user profile statistics comprises a number of projects, a number of reports, and a number of documents associated with a user.

16. A computer program product to optimize a performance of an application by monitoring and measuring health and usage of the application, the computer program product comprising a non-transitory computer-readable medium comprising code causing a first apparatus to:
receive application statistics associated with an application, wherein the application statistics comprise at least one of a user capacity and a utilization capacity, wherein the utilization capacity is based on at least a number of projects, a number of reports per project, and a number of attributes per report;
determine usage statistics associated with the application, wherein the usage statistics are specific to a user type;
monitor in real-time, the usage statistics associated with the application over a predetermined period of time, wherein the usage statistics comprise at least one of a number of active users, a number of active projects, a number of active reports, and a number of active documents;
determine that the application is being over-utilized based on at least comparing the application statistics with the usage statics; and
re-allocate at least one of a number of active users, a number of active reports, and a number of active documents based on at least determining that the application is being over-utilized.

17. The computer program product of claim 16, wherein determining that the application is being over-utilized further comprises:
determining that the number of active users is greater than the user capacity of the application; or
determining that the number of active projects being executed by the application is greater than the utilization capacity of the application.

18. The computer program product of claim 16, wherein the first apparatus is further configured to:
determine a latest user access date when the user has accessed the application to execute a report, a frequency of user access, and a current status of the user; and
determine whether the user access to the application is to be revoked based on at least the latest user access date, the frequency of user access, and the current status of the user.

19. The computer program product of claim 16, wherein the first apparatus is configured to verify one or more authentication credentials associated with each user type to enable access to the application, wherein the user type used by said at least one processor to determine usage statistics comprises at least one of an application developer, an administrator, a business user, and a business executive.

20. The computer program product of claim 16, wherein the first apparatus is further configured to:
determine a top report associated with a project based on at least a number of times a user has executed the report using the application and a frequency of execution of the top report using the application;
determine that an average amount of time associated with the execution of the top report by the user is greater than a predetermined threshold time, thereby causing an application laggard, wherein the top report is executed after an authorization of user access to the application;
execute the top report prior to the authorized user access based on the frequency of execution of the top report; and
transmit the executed top report to the user, thereby enabling the user to access the executed top report without the need for the user to access the application to execute the top report.
